(19) United States
(12) Patent Application Publication
(10) Pub. No.: US 2005/0014858 A1
(43) Pub. Date: Jan. 20, 2005

(54) Urethane polyol prepolymer, porous polyurethane sheet and method of preparing the same

(76) Inventors: Keun-Bae Choi, Suwon-si (KR); Hyoung-Sug Kim, Suwon-si (KR); Tae-Ja Kim, Siheung-si (KR)

Correspondence Address: CANTOR COLBURN LLP, 55 Griffin Road South, Bloomfield, CT, 06002, US

(21) Appl. No.: 10/889,959

(22) Filed: Jul. 13, 2004

(30) Foreign Application Priority Data
Jul. 15, 2003 (KR) 2003-48414

(51) Int. Cl. C08G 18/00

(52) U.S. Cl. 521/155

(57) ABSTRACT

A porous polyurethane sheet includes a urethane polyol prepolymer having an easy storing and handling characteristic. The urethane polyol prepolymer is in a semi-solid state or a solid state at room temperature, and includes a urethane functional group on the main chain thereof along with at least two hydroxyl functional groups. The urethane polyol prepolymer is heated to melt, and an isocyanate compound containing an isocyanate functional group for reacting with the hydroxyl functional group, and a urethane curing catalyst are added and stirred at high speed to form mechanically foamed material. Thus formed mechanically foamed material is cooled to room temperature with or without pressure applied to form a porous polyurethane sheet. Thus formed porous polyurethane has good physical and chemical properties.

### CROSS-REFERENCE TO RELATED APPLICATION

This application relies for priority upon Korean Patent Application No. 2003-48414 filed on Jul. 15, 2003, the contents of which are herein incorporated by reference in its entirety.

### BACKGROUND OF THE INVENTION

1. Field of the Invention

The present invention relates to a porous polyurethane sheet and a method of preparing the same, and more particularly, to a porous polyurethane sheet obtained by just melting and stirring urethane polyol prepolymer, which is easy to handle and has a good storing property, without using any solvent or a dryer and a method of preparing the porous polyurethane sheet.

2. Description of the Related Art

Porous polyurethane used in chemical products including various artificial leather, synthetic leather, textile processing and the like, is prepared by a wet method and a dry method.

According to the wet method, polyurethane resin including hydrophilic organic solvent such as dimethyl formamide is dipped into water to solidify, so that a porosity is obtainable in water by using a diffusion of the hydrophilic organic solvent.

According to the dry method, water or low-boiling solvent as a foaming agent is mixed into a polyol compound containing an isocyanate functional group and a hydroxyl functional group or a polyol compound containing an amine functional group, or is mixed into a mixture thereof so as to be reacted to generate a carbonate gas. Then the carbonate gas or an evaporated gas from the solvent having a low boiling point is used for foaming.

A method of foaming by mixing a urethane resin with a thermo-decomposable foaming agent, coating thus obtained mixture and heating to decompose the foaming agent to generate a gas including nitrogen gas, has been disclosed.

A method of foaming by stirring rapidly a polyurethane emulsion or a dispersed material in water while blowing air is also disclosed. Thus foamed product is coated on a substrate and then is dried.

However, according to the above-described conventional method, thus obtained porous polyurethane material should be heated after the coating and the producing efficiency for the porous polyurethane material is low. In addition, a large-scaled equipment is required and a great amount of energy is consumed for executing the heating and drying process.

Further, when the applied organic solvent is evaporated into the air or leaked out as a waste, the problem concerning an environmental pollution might be resulted. When the thickness of the coating is excessively thick or excessively thin, a porous polyurethane material having a homogeneous porosity is hard to obtain.

In order to solve the above-described problems, Korean Patent Laid-Open Publication No. 2002-0050138 discloses a cream-typed mechanically foamed body. Polyurethane prepolymer containing an isocyanate functional group in a semi-solid state or a solid state is heated and melted at a temperature of about 60 to about 250° C. Then, the polyurethane prepolymer, a compound reactionary with the isocyanate functional group and/or a urethane curing catalyst are mixed and stirred at high speed using a mixing head. A gas is introduced while stirring at high speed to mechanically foam to obtain a mechanically foamed body having a cream shape. Thus formed mechanically foamed body is cooled or compressed at a room temperature to prepare a polyurethane porous material having a high tearing and flaking strength.

After executing laboratory experiments by the present inventors, however, it has been found that some problems concerning practical application and commercialization are according to the above-described method. The preparation of the urethane prepolymer containing the isocyanate functional group in the semi-solid state or the solid state according to the above-described method is difficult by a general method. In practical, commercially available goods are produced within the limits to just three or four companies worldwide, thus proving the difficulty of the preparation of the urethane prepolymer.

The shape of the urethane prepolymer containing the isocyanate functional group according to the above-described method is very susceptible to deform or to be modified through a reaction with humidity. Therefore, the storing of the urethane prepolymer is not easy. When the storing is required, a special packing method should be applied at a large cost.

In order to confirm the stability of the urethane prepolymer containing the isocyanate functional group during melting at a high temperature, an apparatus for preventing a contact of the urethane prepolymer with humidity is required. The working hour also should be minimized to lessen the contacting time of the urethane prepolymer with the humidity. Therefore, the confirmation of the quality of the applied products of the polyurethane prepolymer containing the isocyanate functional group is very difficult owing to the above-described defects.

### SUMARY OF THE INVENTION

Accordingly, the present invention considering the above-described problems provides a urethane polyol prepolymer of which storing and handling are easy and by which a stability of production can be confirmed during preparing a porous polyurethane material since much attention is not required during the handling.

The present invention also provides a porous polyurethane sheet having good physical properties including a heat-resistance, a solvent-resistance, a flaking strength, a tear strength, and the like by using the urethane prepolymer of which handling and storing are easy.

The present invention still also provides a method of preparing a porous polyurethane sheet having good physical and chemical properties without inducing an environmental problem by using the polyurethane prepolymer of which storing and handling are easy.

In accordance with one aspect of the present invention, a urethane polyol prepolymer includes a urethane functional group on a main chain of the urethane polyol prepolymer and at least two hydroxyl functional groups. The urethane polyol prepolymer is in a semi-solid state or a solid state at a room temperature.

In accordance with another aspect of the present invention, a porous polyurethane sheet is produced by mixing a urethane polyol prepolymer containing a urethane functional group on a main chain of the prepolymer and at least two hydroxyl functional groups, with an isocyanate compound containing an isocyanate (—NCO) functional group that possibly reacts with the hydroxyl functional groups and a urethane curing catalyst, foaming a mechanically foamed material by implementing one of a stirring in a high speed and an introduction of a gas and then cooling or cooling while compressing at a room temperature.

In accordance with still another aspect of the present invention, a method of preparing a porous polyurethane sheet is provided as follows.

First, a urethane polyol prepolymer containing a urethane functional group on a main chain of the prepolymer and at least two hydroxyl functional groups is prepared. The prepolymer is a semi-solid state or a solid state at a room temperature. Then, the urethane polyol prepolymer is melted at a temperature range of about 40 to about 250° C. Subsequently, thus obtained molten urethane polyol prepolymer, an isocyanate compound containing at least two isocyanate (—NCO) functional groups for reacting with the hydroxyl functional groups and a urethane curing catalyst are mixed and stirred. A mechanically foamed material is formed through performing one of a process of a stirring thus mixed and stirred product in a high speed and a process of introducing a gas. Then, the mechanically foamed material may be or may be not cooled under a pressure at a room temperature.

As described above, the polyurethane polyol prepolymer according to the present invention is a semi-solid state or a solid state at room temperature, so that the storing and the handling thereof are easy. When a porous polyurethane sheet is prepared by using the urethane polyol prepolymer, much attention during the preparation is not required and so the producing efficiency may be consistent. In addition, a porous polyurethane sheet having good physical and chemical properties may be prepared without generating an environmental problem while consuming a small amount of energy.

### BRIEF DESCRIPTION OF THE DRAWINGS

The above features and advantages of the present invention will become more apparent by describing preferred embodiments in detail with reference to the attached drawings in which:

FIG. 1 is a picture illustrating a cross-sectional view of a porous polyurethane sheet formed according to Embodiment 2 of the present invention;

FIG. 2 is a picture illustrating a cross-sectional view of a porous polyurethane sheet formed according to Embodiment 5 of the present invention;

FIG. 3 is a picture illustrating a cross-sectional view of a porous polyurethane sheet formed according to Comparative Example 1 of the present invention;

FIG. 4 is a picture illustrating a cross-sectional view of an artificial leather including a porous polyurethane sheet formed according to Embodiment 6 of the present invention; and

FIG. 5 is a picture illustrating a cross-sectional view of an artificial leather including a porous polyurethane sheet formed according to Embodiment 7 of the present invention.

### DESCRIPTION OF THE INVENTION

The present invention will be described in detail hereinafter.

Urethane Polyol Prepolymer

A urethane polyol prepolymer according to the present invention is in a semi-solid state or a solid state at a room temperature and has a urethane functional group in a main chain of the polymer. The polymer includes at least two hydroxyl functional groups (—OH) and has a molten viscosity of about 500 to about 100,000 cps at a temperature of about 120° C.

Here, when number of the hydroxyl functional group of the urethane polyol prepolymer is less than two, curing of the porous polyurethane sheet may be difficult. When the number of the hydroxyl functional group exceeds six, a cross-linking degree of the porous polyurethane sheet increases to deteriorate flexibility of the cured coating layer and the viscosity increases to lower a working efficiency.

Therefore, the number of the hydroxyl functional group of the urethane polyol prepolymer is about 2 to about 6, and is preferably about 2 to about 4.

When the molten viscosity of the urethane polyol prepolymer is less than 500 cps at a temperature of about 120° C., the foaming property when forming the porous polyurethane sheet is deteriorated and solidification of the urethane polyol prepolymer is not accomplished even by cooling the urethane polyol prepolymer.

When the molten viscosity of the urethane polyol prepolymer exceeds 100,000 cps at a temperature of about 120° C., a homogeneous mixing is difficult, so that preparation of a homogeneous and porous polyurethane sheet may be difficult. Further, movement or discharge of the urethane polyol prepolymer from a pump is hard due to a high viscosity of the polyol prepolymer.

Therefore, the molten viscosity of the urethane polyol prepolymer is in the range of about 500 to about 100,000 cps, and preferably in the range of about 1,000 to about 50,000 cps.

The urethane polyol prepolymer having the above-described properties is obtainable by mixing and reacting 1 equivalent weight of isocyanate compound with about 1.1 to about 2.5 equivalent weight of polyol compound at a temperature of about 70 to about 120° C.

When the equivalent weight of the polyol compound based on 1 equivalent weight of the isocyanate compound is less than about 1.1, both terminal portions of the urethane polyol prepolymer may not be hydroxyl functional groups and the viscosity of the urethane polyol prepolymer is increased due to an increase of the molecular weight.

When the equivalent weight of the polyol compound exceeds 2.5, the molecular weight of the urethane polyol prepolymer becomes small and the properties after completing processing the urethane polyol prepolymer are deteriorated.

Therefore, the mixing ratio of the polyol compound with respect to 1 equivalent weight of isocyanate compound is in a range of about 1.1 to about 2.5, and is preferably in a range of about 1.8 to 2.1.

When a reaction temperature of the polyol compound and isocyanate compound is lower than about 70° C., the reaction does not completely proceed and time for the reaction is increased to lower an economic producing efficiency. In addition, since the urethane polyol prepolymer prepared by the reaction is in a solid state at a temperature lower than about 70° C., synthesis of the urethane polyol prepolymer may be difficult. When the reaction temperature exceeds about 120° C., an adverse reaction to the preparation of the urethane polyol prepolymer having desired properties may occur so as to inhibit the preparation of the urethane polyol prepolymer.

Therefore, the reaction temperature of the polyol compound and isocyanate compound to prepare the urethane polyol prepolymer is in the range of about 70 to about 120° C.

Examples of the polyol compound used for preparing the urethane polyol prepolymer according to the present invention are a polyester-based polyol compound, lactone-based polyol compound, a polycarbonate-based polyol compound, a polyether-based polyol compound, and the like. The above compounds may be used alone or in a mixture of two or more.

Examples of the isocyanate comound used for preparing the urethane polyol prepolymer are toluene diisocyanate, diphenylmethane diisocyanate, modified diphenylmethane diisocyanate, naphthalene diisocyanate, phenylene diisocyanate, hexamethylene diisocyanate, lysine isocyanate, cyclohexane diisocyanate, isoporone diisocyanate, xylene diisocyanate, tetramethyl xylene diisocyanate, norbornene diisocyanate, triphenyl methane triisocyanate, polyphenyl polymethylene polyisocyanate, polyisocyanate containing a carbodiimide functional group, a polyisocyanate compound containing an allophanate functional group and a polyisocyanate compound containing an isocyanurate functional group. The above compounds may be used alone or in a mixture of two or more.

The urethane polyol prepolymer having the above-described properties is used for preparing a porous polyurethane sheet. The handling and storing of the urethane polyol prepolymer are advantageously simple and easy, and a deformation due to the humidity is not readily generated. In addition, much attention is not required during preparing the porous polyurethane sheet to confirm a stability of producing the same.

Porous Polyurethane Sheet and Method of Preparing the Same

The porous polyurethane sheet has good physical properties and chemical properties such as a solvent-resistance, a heat-resistance, a flaking strength and a tear strength. In addition, the thickness of the sheet may be advantageously controlled and the problem concerning the homogeneous thickness in the conventional methods may be solved. Further, when the porous polyurethane sheet is coated on a foamed sheet structure body, non-foamed sheet structure body, a non-woven fabric or fiber textile, the same properties may be obtained.

The porous polyurethane sheet according to the present invention is prepared by mixing and stirring a urethane polyol prepolymer in a semi-solid state or a solid state at room temperature. The urethane polyol prepolymer includes a urethane functional group on a main chain of the prepolymer and at least two hydroxyl functional groups, an isocyanate compound containing an isocyanate functional group (—NCO) that is reacted with the hydroxyl functional group, and a urethane curing catalyst. Thus obtained mixture is stirred in a high speed or is introduced with a gas to form a cream-typed machanically foamed material. The mechanically foamed material is cooled with or without applying pressure at a room temperature.

An explanation on the urethane polyol prepolymer will be omitted to avoid a repetition.

The isocyanate compound containing the isocyanate functional group (—NCO) that is reacted with the hydroxyl function group is reacted with the urethane polyol prepolymer containing a urethane functional group on the main chain thereof and about 2 to about 4 numbers of hydroxyl function groups (OH).

That is, the isocyanate compound may be a single molecular typed isocyanate compound containing two or more isocyanate functional groups or an isocyanate prepolymer including the single molecular-typed isocyanate compound. The isocyanate compound is used by about 0.8 to about 3 equivalent weight based on about 1 equivalent weight of the urethane polyol prepolymer.

When the isocyanate compound is used by about 0.8 equivalent weight or less, based on about 1 equivalent weight of the urethane polyol prepolymer, a curing degree is not sufficient and the thermal properties and the physical properties of thus formed porous poly urethane sheet are deteriorated and the formation of pores is weak. When the isocyanate compound is used by about 3 equivalent weight or over based on about 1 equivalent weight of the urethane polyol prepolymer, the surface portion of the porous polyurethane sheet becomes non-uniform due to a foaming phenomenon. In addition, a cross-linking degree is increased to greatly lower the flexibility of the porous polyurethane sheet.

Therefore, about 1 to about 3 equivalent weight of the isocyanate compound is used based on 1 equivalent weight of the urethane polyol prepolymer, and more preferably, about 1 to about 2 equivalent weight of the isocyanate compound is used based on about 1 equivalent weight of the urethane polyol compound.

The above-described isocyanate compound includes an isocyanate functional group. Examples of the isocyanate compound containing an isocyanate functional group include an aromatic diisocyanate compound such as toluene diisocyanate, diphenylmethane diisocyanate, naphthalene diisocyanate and phenylene diisocyanate, hexamethylene diisocyanate, lysine isocyanate, cyclohexane diisocyanate, isophorone diisocyanate, xylene diisocyanate, tetramethyl xylene diisocyanate, norbornene diisocyanate, triphenylmethane triisocyanate, polyphenyl polymethylene polyisocyanate, a polyisocyanate containing a carbodiimide functional group, a polyisocyanate compound containing an allophanate functional group and a polyisocyanate compound containing an isocyanurate functional group. The above compounds may be used alone or in a mixture of thereof.

Examples of the urethane curing catalyst used for preparing the porous polyurethane sheet includes a tertiary amine compound, an organo-metallic compound such as tin(II) octoate, dibutyl tin diacetate, dibutyl tin dilaurate, an amidine compound having two rings such as 1,8-diaza-bicyclo (5, 4, 0) undecene-7 (hereinafter, simply referred to as “DBU”), DBU-p-toluene sulfonic acid salt, DBU-formic acid salt, DBU-octyl acid salt, and a mixture of thereof.

As the urethane curing catalyst, water, polyurethane, various kinds of emulsion including polyacryl, various kinds of latex and the like may be used. The urethane curing catalyst may be added while mixing the urethane polyol prepolymer with the isocyanate compound or may be previously mixed with the urethane polyol prepolymer before mixing the urethane polyol prepolymer with the isocyanate compound.

The amount of the urethane curing catalyst is in a range of about 0.0001 to about 10 parts by weight based on the urethane polyol prepolymer. Here, when the amount of the urethane curing catalyst is less than about 0.0001 part by weight, the curing reaction is slowed down. Further, air bubbles are broken or become unstable. When the amount of the urethane curing catalyst exceeds about 10 parts by weight, the curing reaction is excessively promoted to result in an excessive foaming or an instant gelling.

Therefore, the amount of the urethane curing catalyst is in a range of about 0.0001 to about 10 parts by weight based on the amount of the urethane polyol prepolymer, and more preferably, the amount is in a range of about 0.01 to about 5 parts by weight.

When preparing the porous polyurethane sheet by mixing the urethane polyol prepolymer, the isocyanate compound and the urethane curing catalyst, an improving agent such as a foam stabilizer, an anti-oxidant, an ultraviolet absorbent, a climate-resistance improving agent, a deodorizer, a water permeability improving agent, a conductivity imparting agent, an antistatic agent, a blocking preventing agent, a coupling agent, a water repellent, a hydrolysis preventing agent, a dye, a pigment, a filler, a hollow foaming agent, thermal decomposing typed foaming agent, a crystal water-containing compound, dioctyl phthalic acid ester, various plasticizer, a thermoplastic resin, a thermosetting resin and an adhesiveness imparting agent may be added.

As the foam stabilizer, the conventionally known organic silicon surfactant such as commercially available SF-2908, SF-2904, SRX-274C, SH-3746, SF-2944F, SH-193, SF-2945F (trade names manufactured by Toray Dow Corning Silicon Co. Ltd.), and the like may be used.

An amount of the foam stabilizer applied for forming the porous polyurethane sheet is in the range of about 0.01 to about 20 parts by weight based on the amount of the urethane polyol prepolymer. When the amount of the foam stabilizer is less than about 0.01 parts by weight, generating bubbles is not advantageous. When the amount of the foam stabilizer exceeds about 20 parts by weight, thus formed porous polyurethane sheet may not have a good physical strength and a mechanical strength. A bleed phenomenon may also occur.

The adhesiveness imparting agent includes a rosin ester derivative, a petroleum resin, a terpene resin, a xylene resin, a ketone resin, and the like. The thermoplastic resin for improving the property includes a polyurethane resin, a poly ester resin, a poly amide resin, an acryl resin, an ethylene-vinyl acetate copolymer, a poly olefin resin, a styrene-based elastic polymer, polyvinyl chloride and the like.

In order to prepare the porous polyurethane according to the present invention, a urethane polyol prepolymer in a semi-solid state or a solid state and containing a urethane functional group on the main chain of the polymer and at least two hydroxyl functional groups, is provided. The provided urethane polyol prepolymer is melted at a temperature of about 40 to about 250° C. Then, an isocyanate compound containing at least two isocyanate functional groups (—NCO) that are reacted with the hydroxyl functional groups included in the urethane polyol prepolymer, and a urethane curing catalyst are heated to a temperature of about 20 to about 80° C. The urethane polyol prepolymer, the isocyanate compound and the urethane curing catalyst are introduced into a stirring and mixing equipment. Then, the mixture is stirred in a high speed using a mixing head. A gas is provided into the mixture to produce mechanically foamed material. Alternatively, the mixture is stirred at a high speed to produce minute bubbles to a highest degree without providing any gas to obtain mechanically foamed material. Thus formed mechanically foamed material is a cream type. Then, the mechanically foamed material is molded into a predetermined shape and cooled to a room temperature. Alternatively, the cooling is implemented with pressure to obtain a porous polyurethane sheet.

The porous polyurethane sheet having uniform and minute pores may be prepared by introducing the urethane polyol prepolymer, the isocyanate compound and the urethane curing catalyst into a stirring vessel, then introducing a gas and subsequently stirring again at high speed. The gas may be introduced before mixing raw materials and the stirring is implemented at high speed. Alternatively, the gas is previously introduced into the urethane polyol prepolymer and is stirred at high speed. Then, the isocyanate compound and the urethane curing catalyst may be mixed. The urethane polyol prepolymer and the urethane curing catalyst may be mixed in advance.

When the mixing is performed by using the mixing head, the temperature is maintained within a range of about ±30° C. of the melting point of the urethane polyol prepolymer. The temperature range of about ±30° C. of the melting point is preferred since the stirring is advantageous, the curing rate is increased and a uniform and porous polyurethane sheet is prepared comparing with a room temperature.

The gas for foaming includes air, nitrogen gas, carbonate gas, argon gas and the like. The gas may be pre-heated.

According to the mechanical foaming, the gas is introduced while mixing the urethane polyol prepolymer, the isocyanate compound and the urethane curing catalyst. Alternatively, the gas may be not introduced while the mixture is stirred at high speed by using an equipment such as a mixing head with a speed of about 1,000-8,000 rpm to form mechanically foamed material including bubbles.

When the gas is introduced, the foaming degree is increased and the polyurethane having a high pore-forming efficiency may be obtained. In addition, the viscosity of the mechanically foamed material is lowered, and the stirring and mixing and the introducing of the mechanically foamed material are advantageous. When the gas is not introduced, the polyurethane having compact pores may be produced, so that the properties such as the flaking strength, the tensile strength and the abrasion strength of the porous polyurethane sheet are improved.

When rotation speed of the mixing head during performing the stirring in a high speed is less than about 1,000 rpm, the mixing of the mixture may be not sufficient, the size of the foamed cells may be large and the foaming may be non-uniform. When the rotation speed of the mixing head exceeds about 8,000 rpm, an excessive load is applied to the mixing head and a general working becomes difficult.

In the present invention, the application of the pressure includes pressing the surface of the cream-type and mechanically foamed material by using a smooth roll, an embossing roll, a liner, etc., to smooth the surface portion even further or to control the thickness of the sheet while forming a desired concavo-convex shape or pattern. By applying the pressure, the strength of the sheet may be greatly improved.

The porous polyurethane sheet and the porous sheet including the porous polyurethane sheet prepared by the above-described method have good physical and chemical properties such as a heat-resistance, a solvent-resistance, a flaking strength and a tear strength and the like. In addition, since the thickness precision of the sheet may be improved when compared with the conventional method, a porous polyurethane sheet having a uniform thickness may be formed.

A porous polyurethane sheet structure may be also obtained by using the porous polyurethane sheet of the present invention, wherein the structure may be obtained by the same manner of preparing the porous polyurethane sheet. The mechanically foamed material is coated on a sheet shaped body such as various plastic sheets, a non-woven fabric, a fiber textile and a knitted textile, then adhered thereto and cooled at a room temperature or under a pressurized atmosphere at a room temperature.

Thus formed porous polyurethane sheet and the porous polyurethane sheet structure may be used as a synthetic leather and an artificial leather such as shoes, bag, clothing, hat and various cases. Further, the product may be used as an impact absorbent, a material for a speaker edge portion, a material for a non-slipper, a buffering material, a heartwood, a wall decorating material, a puff for a makeup and the like.

Preferred embodiments of the present invention will be described in more detail below. However, it should be understood that the present invention is not limited to the following Examples.

Preparation of Urethane Polyol Prepolymer

### EXAMPLE 1

A round flask was provided with a thermometer, a nitrogen gas introducing apparatus, a mixer and a heating apparatus to establish a reacting vessel. Into the flask, 400 g of polytetramethylene glycol (PTMG, Mw=2,000, manufactured by BASF Co., Germany) and 400 g of 1,6-hexanediol adipic acid ester (Mw=2,000, manufactured by Daewon Polymer Co. Ltd. Korea) were introduced. The temperature was raised to 110° C. and then a de-foaming was performed in vacuum for 1 hour. Then, a nitrogen gas was introduced while releasing the vacuum, and the temperature was lowered to 50° C. 50 g of 4,4-diphenylmethane diisocyanate (commercially available as a trade name of p-MDI, manufactured by Kumho-mitsui Chemical Co., Korea) was added and the temperature was raised to 75° C. The reaction was carried out while passing the nitrogen gas for 1 hour the reacting vessel. After 1 hour, a sample was taken therefrom and inspected by using an FT-IR instrument to confirm a disappearance of a peak around 2200 cm⁻¹, wherein the peak represented the isocyanate functional group. When a removal of the isocyanate functional group was confirmed, the reacted product was widely spread on a liner to cool and to obtain a urethane polyol prepolymer containing a urethane functional group on the main chain of the prepolymer and 2-4 numbers of hydroxyl functional groups. The urethane polyol prepolymer was in a semi-solid state or a solid state at a room temperature. The viscosity of thus obtained urethane polyol prepolymer was 3,900 cps (Brookfield LVDV-II+, #3, 12 rpm) at a temperature of 120° C.

Preparation of Porous Polyurethane Sheet

### EXAMPLE 2

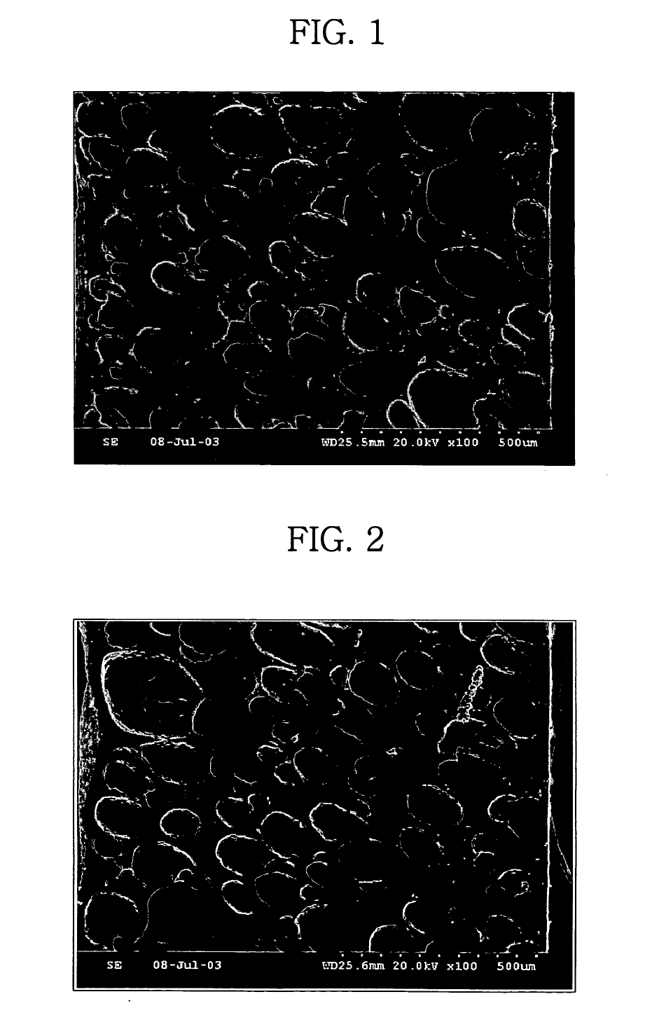

The urethane polyol prepolymer prepared by Example 1 was heated to a temperature of 120° C. to melt and then was kept in a warm-keeping vessel at a temperature of 120° C. Then, an isocyanate compound (commercially available as a trade name of COSMONATE LL, Kumho-Mitsui Chemical Co., Japan) and a mixture of an amine-based curing catalyst (commercially available as a trade name of PC CAT TD 33, manufactured by Nitroil Co., Germany) with a foam stabilizer (commercially available as a trade name of DC-193, manufactured by Dow Corning Co., U.S.A.) in a mixing ratio of 5:30% by weight, were allowed to stand under a temperature of 30° C. in a warm-keeping vessel. Into a warm-keeping vessel at a temperature of 120° C., the urethane polyol prepolymer, the isocyanate compound and the mixture of the amine-based curing catalyst with the foam stabilizer were introduced in a mixing ratio of 85:17:1.8% by weight based on the total amount of 100% by weight. Then, the mixture was stirred at high speed of 5,000 rpm for 1 second. Subsequently, a nitrogen gas was introduced while stirring at high speed of 5,000 rpm for 2 seconds so that cream-typed bubbles may be generated to form mechanically foamed material having a density of 0.3. Thus formed mechanically foamed material was poured onto a soft liner and was coated uniformly to a thickness of about 450 μm by using a coating bar. The coated material was cooled to room temperature to obtain a porous polyurethane sheet having uniform, minute and continuous pores, a thickness of about 450 μm and good physical properties. The physical properties of the porous polyurethane sheet are shown in Table 1 and a picture taken by an electron microscope for illustrating the cross-section thereof is shown in FIG. 1.

### EXAMPLE 3

The foamed mixture prepared in the same method as in Example 2 was coated on a liner, and another liner was put on the coated material. Then, the coated layer was pressed by using a mangle roll so that the thickness of the coated layer would be about 400 μm. Then, the product was cooled to room temperature to obtain a porous polyurethane sheet having minute and uniform pores, a thickness of about 400 μm and good physical properties. The physical properties of the porous polyurethane sheet are shown in Table 1.

### EXAMPLE 4

The foamed mixture prepared in the same method as in Example 2 was coated on a liner, and another liner was put on the coated material. Then, the coated layer was pressed by using a mangle roll so that the thickness of the coated layer was to be about 300 μm. Then, the product was cooled to room temperature to obtain a porous polyurethane sheet having minute and uniform pores, a thickness of about 300 μm and good physical properties. The physical properties of the porous polyurethane sheet are shown in Table 1.

### EXAMPLE 5

The foamed mixture was prepared in the same method as in Example 2 except that the urethane polyol prepolymer was used after allowing the urethane polyol prepolymer to stand at a room temperature for six days (25° C., 75RH %). The foamed mixture was uniformly coated on a liner by using a coating bar so that a coated thickness was 450 μm. Subsequently, the product was cooled to room temperature to obtain a porous polyurethane sheet having minute and uniform pores, a thickness of about 450 μm and good physical properties. The physical properties of the porous polyurethane sheet are shown in Table 1 and a picture for illustrating a cross-sectional view of the porous polyurethane sheet by an electron microscope is shown in FIG. 2.

### COMPARATIVE EXAMPLE 1

An ester-based urethane prepolymer, a thermoplastic urethane resin including isocyanate compound disclosed in Korean Patent Laid-Open Publication No. 2002-0050138, was allowed to stand at room temperature for six days (25° C., 75RH %) instead of the urethane polyol prepolymer in Example 1.

First, ester-based urethane prepolymer (commercially available as a trade name of Takeda-melt SC-13, manufactured by Takeda Yakuhing Kokyo Co. Ltd, Japan) was heated to melt at a temperature of 120° C. and was kept in a warm-keeping vessel at a temperature of 120° C. Then, polyethertriol (commercially available as a trade name of Mitsui Polyol MN-3050, manufactured by Mitsui Chemicals, Inc, Japan), and a mixture of amine-based curing catalyst (commercially available in the market as a trade name of Miniko L-1020, manufactured by Katsusai Chemicals, Inc, Japan) and a foam stabilizer (commercially available as a trade name of SF-2964, manufactured by Toray Dow Corning Silicon Inc., U.S.A.) were kept to a temperature of 30° C.

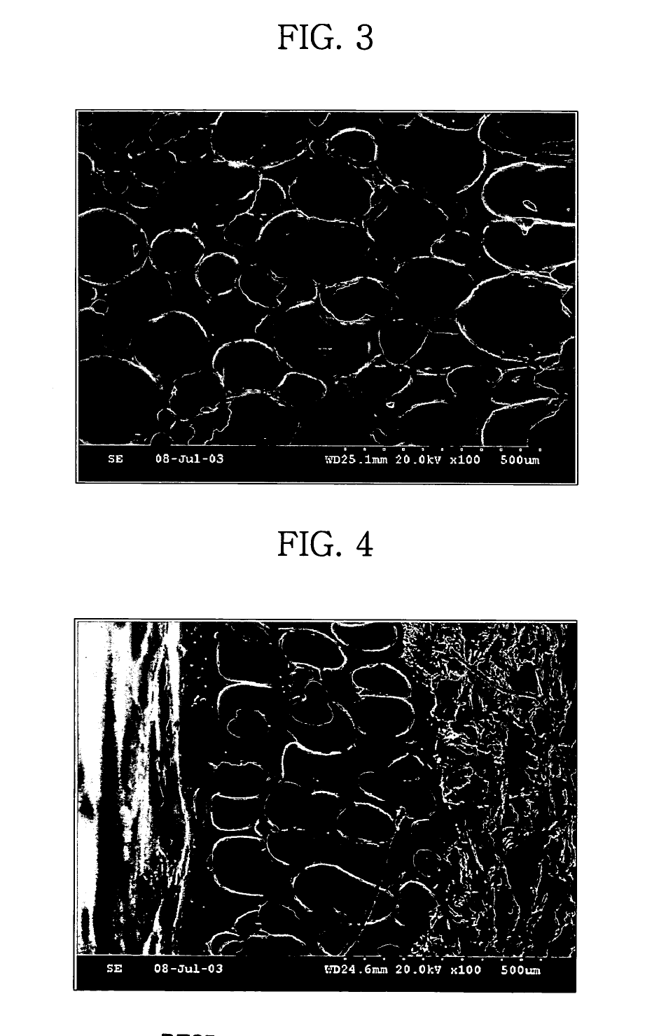

Subsequently, into a warm-keeping vessel at a temperature of 120° C., the ester-based urethane prepolymer, polyethertriol and the mixture of the amine-based curing catalyst with the foam stabilizer were introduced by a mixing ratio of 65:5:30% by weight based on the total amount of 100% by weight. Then, the mixture was stirred at high speed of 5,000 rpm for 1 second. A nitrogen gas was introduced while stirring at high speed of 5,000 rpm for 2 seconds so that cream-typed bubbles might be generated to form mechanically foamed material having a density of 0.3 g/ml. Thus formed mechanically foamed material was poured onto a soft liner and coated uniformly to a thickness of about 450 μm by using a coating bar. The coated material was cooled to room temperature to obtain a porous polyurethane sheet having a thickness of about 450 μm. The physical properties of the porous polyurethane sheet are shown in Table 1 and a picture taken by an electron microscope for illustrating the cross-section thereof is shown in FIG. 3.

### COMPARATIVE EXAMPLE 2

Commercially available polyurethane porous sheet formed by a wet method and having a thickness of about 300 μm was prepared and the physical properties thereof were measured and illustrated in Table 1.

TABLE 1
Result of measured physical properties

| | | Thick- | Modulus (Kg/cm²) | | | | | Tensile | Elonga- | Flaking |
|---|---|---|---|---|---|---|---|---|---|---|
| | Comp- | ness | 10% | 50% | 100% | 200% | 300% | strength | tion | strength |
| Sample | Ression | (μm) | M | M | M | M | M | (Kg/cm²) | (%) | (Kg/cm²) |
| Example 2 | None | 450 | 1.92 | 5.57 | 8.05 | 10.34 | 14.23 | 21.5 | 705 | 1.84 |
| Example 3 | Yes | 400 | 4.01 | 9.86 | 12.56 | 19.33 | 26.29 | 50.35 | 735 | 2.97 |
| Example 4 | Yes | 300 | 8.17 | 17.34 | 22.05 | 31.22 | 40.35 | 83.20 | 769 | 3.85 |
| Example 5 | None | 450 | 1.92 | 5.57 | 8.05 | 10.34 | 14.23 | 21.5 | 705 | 1.84 |
| Com. | None | 450 | 1.02 | 3.56 | 4.97 | 7.08 | 8.54 | 12.81 | 549 | 0.97 |
| Example 1 | | | | | | | | | | |
| Com. | — | 300 | 8.44 | 22.94 | 32.77 | 46.00 | — | 50.12 | 259 | 1.31 |
| Example 2 | | | | | | | | | | |

*Tensile strength, elongation: the values were determined when judging, and the measuring was executed by referring to KS M 6782.
**Flaking strength: the values were measured by referring to KS K 0533.
In Table 1, Com. Example means Comparative Example,

Referring to the physical properties on the porous polyurethane sheet illustrated in Table 1, it can be noted that the values of Modulus for Comparative Example 2 are much higher from 10% M to 100% M when compared with those for Examples 2-5. This result shows that the softness of the polyurethane porous sheet of Comparative Example 2 is inferior to that of the porous polyurethane sheet of examples of the present invention. In addition, the elongation when breaking and the tensile strength of the porous polyurethane sheet according to Examples 2-5 are much better than those of the polyurethane sheet according to Comparative Examples. That is, the porous polyurethane sheets according to the present invention have even better physical properties.

The polyurethane sheet prepared by Comparative Example 1 includes large-sized and irregular inner cells (porous body) as illustrated in FIG. 3. As for the physical properties, each characteristic is much inferior to that of Example 5. This result indirectly implies that the ester-based urethane prepolymer according to Comparative Example 1 includes potential problems and these problems might be always generated during storing. Accordingly, a considerable expense is required and difficulty is present for acquiring the stability of production.

The result of Example 5 by which urethane polyol prepolymer used after being allowed to stand for six days at a room temperature is similar to those of Examples 2 to 4. Considering the result, the polyol urethane prepolymer according to the present invention has a good storing property and a good handling property, and the humidity is not needed to control during the preparation. In addition, the end point of the reaction is not required to be accurately controlled. Any special equipment is not required for the preparation of the porous polyurethane sheet. Therefore, the preparing method of the present invention advances in terms of technology, and has a price compatible with the conventional method.

Manufacturing of Artificial Leather by Applying Porous Polyurethane Sheet

### EXAMPLE 6

The urethane polyol prepolymer prepared by Example 1 was heated to a temperature of 120° C. to melt and then was kept in a warm-keeping vessel to a temperature of 120° C. Then, an isocyanate compound (available in the market as a trade name of SP-120V, manufactured by Hepskem Co., Korea, NCO=19%) and a mixture of an amine-based curing catalyst (commercially available as a trade name of PC CAT TD 33, manufactured by Nitroil Co., Germany) with a foam stabilizer (commercially available in the marked as a trade name of DC-193, Dow Corning Co., U.S.A.) in a mixing ratio of 5:30% by weight, were kept to a temperature of 30° C. in a warm-keeping vessel. Into a keep-warming vessel at a temperature of 120° C., the urethane polyol prepolymer, the isocyanate compound and the mixture of the amine-based curing catalyst with the foam stabilizer were introduced by a mixing ratio of 85:17:1.8% by weight based on the total amount of 100% by weight. Then, the mixture was stirred in a high speed of 5,000 rpm for 1 second. Subsequently, a nitrogen gas was introduced while stirring in a high speed of 5,000 rpm for 2 seconds so that cream-typed bubbles might be generated to form mechanically foamed material having a density of 0.3 g/ml. A skin of the urethane elastic polymer having thus formed mechanically foamed material was poured onto an embossing liner that was coated and dried, and coated uniformly to a thickness of about 300 μm by using a coating bar. A urethane impregnated non-woven fabric was combined and then was cooled to room temperature. After keeping at room temperature for 1 day, the liner was removed to obtain an artificial leather suitable for sports shoes, showing good appearance and having uniform, minute and continuous pores. The artificial leather has a flexibility of about 200,000 or more at room temperature and a flaking strength of 2.5 kg/cm or over. A picture taken by an electron microscope for illustrating the cross-section thereof is shown in FIG. 4.

### EXAMPLE 7

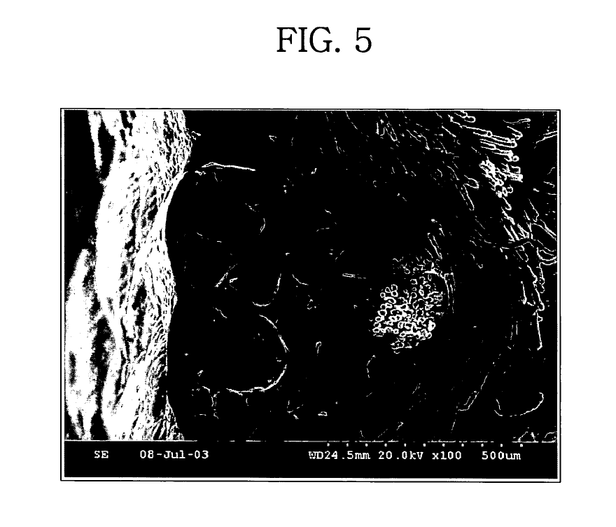

The artificial leather obtained by applying the method described in Example 6 was heated to a temperature of 95° C. and was embossing processed by using an embossing roll to obtain an embossing artificial leather. This leather has a similar appearance with natural leather including sharp embossing. The cross-section of this structure taken by an electron microscope is illustrated in FIG. 5.

Referring to FIG. 5, the compressed cells (porous layer) are not connected to each other after implementing the embossing treatment. Therefore, it is confirmed that the feeling on touching or the volume is rarely changed before and after the embossing treatment.

In particular, since no heating is required after forming the artificial leather, a complex with a material onto which a thermal drying could not be applied, may be easily formed. Particularly, synthetic leather, artificial leather and textile processed goods used as sports shoes having good physical properties, men's shoes, women's shoes, sandals, furniture, car, cloth, bag, case and the like are examples of the complex. Further, using the continuous and porous polyurethane sheet shaped structure having a good impact absorbing property, a good cushioning property and a good durability, shoes, furniture, clothing material, materials for electricity, electronics, building materials, engineering works, etc., may be manufactured.

The urethane polyol prepolymer according to the present invention is advantageous in handling and storing and so that the urethane prepolymer is used when preparing a porous polyurethane sheet. In addition, a problem of deforming due to humidity is not readily occurred. Therefore, not much attention is needed when preparing the porous polyurethane sheet, thereby achieving the stability of production.

The porous polyurethane sheet is prepared by using the urethane polyol prepolymer. An organic solvent or a drier is not used, and a working environment is comfortable and a porous polyurethane sheet having (a high intensity may be obtained economically and efficiently by using a short manufacturing line. At the same time, no harmful solvent to human body remains within the pores of the porous polyurethane sheet, thereby producing environmentally friendly product.

In addition, the porous polyurethane sheet may replace the conventional polyvinyl chloride goods, synthetic leather formed by a wet method, an artificial leather and textile processed goods. Since the producing efficiency and quality for the porous polyurethane sheet are good, various functionality improving products may be obtained from the porous polyurethane sheet instead of the conventional polyurethane.

While the present invention is described in detail referring to the attached embodiments, various modifications, alternate constructions and equivalents may be employed without departing from the true spirit and scope of the present invention.

1. A urethane polyol prepolymer comprising a urethane functional group on a main chain of the urethane polyol prepolymer and at least two hydroxyl functional groups, the urethane polyol prepolymer being in a semi-solid state or a solid state at a room temperature.

2. The urethane polyol prepolymer as claimed in claim 1, wherein a molten viscosity of the urethane polyol prepolymer is in a range of about 500 to about 100,000 mPas at a temperature of about 120° C., and the urethane polyol prepolymer is prepared through an addition reaction of a polyol compound and an isocyanate compound at a temperature range of about 70 to about 120° C.

3. The urethane polyol prepolymer as claimed in claim 2, wherein a mixing ratio of the polyol compound and the isocyanate compound is about 1.1 to about 2.5 equivalent weight of the polyol compound based on about 1 equivalent weight of the isocyanate compound.

4. The urethane polyol prepolymer as claimed in claim 2, wherein the polyol compound is at least one selected from the group consisting of a polyester-based polyol compound, a lactone-based polyol compound, a polycarbonate-based polyol compound and a polyether-based polyol compound.

5. The urethane polyol prepolymer as claimed in claim 2, wherein the isocyanate compound is at least one selected from the group consisting of toluene diisocyanate, diphenylmethane diisocyanate, modified diphenylmethane diisocyanate, naphthalene diisocyanate, phenylene diisocyanate, hexamethylene diisocyanate, lysine isocyanate, cyclohexane diisocyanate, isophorone diisocyanate, xylene diisocyanate, tetramethyl xylene diisocyanate, norbornene diisocyanate, triphenylmethane triisocyanate, polyphenyl polymethylene polyisocyanate, polyisocyanate containing a carbodiimide functional group, polyisocyanate containing an allophanate functional group and polyisocyanate containing an isocyanurate functional group.

6. A porous polyurethane sheet produced by mixing a urethane polyol prepolymer comprising a urethane functional group on a main chain of the urethane polyol prepolymer and at least two hydroxyl functional groups, with an isocyanate compound comprising an isocyanate (—NCO) functional group that may be reacted with the hydroxyl functional groups and a urethane curing catalyst, foaming a mechanically foamed material by implementing one of a stirring in a high speed and an introduction of a gas and then cooling at a room temperature.

7. The porous polyurethane sheet as claimed in claim 6, wherein the cooling is performed under a pressurized atmosphere.

8. The porous polyurethane sheet as claimed in claim 6, wherein a mixing ratio of the urethane polyol prepolymer and the isocyanate compound is about 0.8 to about 3 equivalent weight of the isocyanate compound based on about 1 equivalent weight of the urethane polyol prepolymer.

9. The porous polyurethane sheet as claimed in claim 6, wherein the urethane polyol prepolymer is in a semi-solid state or a solid state at a room temperature, a molten viscosity of the urethane polyol prepolymer is in a range of about 500 to about 100,000 mPas at a temperature of about 120° C., and the urethane polyol prepolymer is prepared through an addition reaction of the polyol compound and the isocyanate compound at a temperature range of about 70 to about 120° C.

10. The porous polyurethane sheet as claimed in claim 9, wherein a mixing ratio of the polyol compound and the isocyanate compound is about 1.1 to about 2.5 equivalent weight of the polyol compound based on about 1 equivalent weight of the isocyanate compound.

11. The porous polyurethane sheet as claimed in claim 9, wherein the polyol compound is at least one selected from the group consisting of a polyester-based polyol compound, a lactone-based polyol compound, a polycarbonate-based polyol compound and a polyether-based polyol compound.

12. A porous polyurethane sheet as claimed in claim 9, wherein the isocyanate compound is at least one selected from the group consisting of toluene diisocyanate, diphenylmethane diisocyanate, modified diphenylmethane diisocyanate, naphthalene diisocyanate, phenylene diisocyanate, hexamethylene diisocyanate, lysine isocyanate, cyclohexane diisocyanate, isophorone diisocyanate, xylene diisocyanate, tetramethyl xylene diisocyanate, norbornene diisocyanate, triphenylmethane triisocyanate, polyphenyl polymethylene polyisocyanate, polyisocyanate containing a carbodiimide functional group, polyisocyanate containing an allophanate functional group and polyisocyanate containing an isocyanurate functional group.

13. The porous polyurethane sheet as claimed in claim 6, wherein the isocyanate compound is a single molecule typed isocyanate compound or an isocyanate prepolymer including the single molecule typed isocyanate.

14. The porous polyurethane sheet as claimed in claim 6, wherein at least one of a foam stabilizer, an anti-oxidant, an ultraviolet absorbent, a climate-resistance improving agent, a deodorizer, a water permeability improving agent, a conductivity imparting agent, an antistatic agent, a blocking preventing agent, a coupling agent, a water repellent, a hydrolysis preventing agent, a dye, a pigment, a filler, a hollow foaming agent, a thermal decomposing-typed foaming agent, a crystal water-containing compound, dioctyl phthalic acid ester, a thermoplastic resin and a thermosetting resin is added during mixing the isocyanate and the urethane curing catalyst with the urethane polyol prepolymer.

15. A method of preparing a porous polyurethane sheet comprising:
(a) preparing a urethane polyol prepolymer containing a urethane functional group on a main chain of the urethane polyol prepolymer and at least two hydroxyl functional groups, the prepolymer being in a semi-solid state or a solid state at a room temperature;
(b) melting the urethane polyol prepolymer at a temperature range of about 40 to about 250° C.;
(c) mixing and stirring thus obtained molten urethane polyol prepolymer with an isocyanate compound containing at least two isocyanate (—NCO) functional groups for reacting with the hydroxyl functional groups and a urethane curing catalyst;
(d) forming a mechanically foamed material through performing one of a process of a stirring thus mixed and stirred product in a high speed and a process of introducing a gas; and
(e) cooling the mechanically foamed material.

16. The method of preparing a porous polyurethane sheet as claimed in claim 15, wherein the cooling the mechanically foamed material is performed under a pressurized atmosphere.

17. The method of preparing a porous polyurethane sheet as claimed in claim 15, wherein a mixing ratio of the urethane polyol prepolymer and the isocyanate compound is about 0.8 to about 3 equivalent weight of the isocyanate compound based on about 1 equivalent weight of the urethane polyol prepolymer.

18. The method of preparing a porous polyurethane sheet as claimed in claim 15, wherein a molten viscosity of the urethane polyol prepolymer is in a range of about 500 to about 100,000 mPas at a temperature of about 120° C. and the urethane polyol prepolymer is prepared through an addition reaction of polyol compound and isocyanate compound at a temperature range of about 70 to about 120° C.

19. The method of preparing a porous polyurethane sheet as claimed in claim 18, wherein a mixing ratio of the polyol compound and the isocyanate compound is about 1.1 to about 2.5 equivalent weight of the polyol compound based on about 1 equivalent weight of the isocyanate compound.

20. The method of preparing a porous polyurethane sheet as claimed in claim 18, wherein the polyol compound is at least one selected from the group consisting of a polyester-based polyol compound, a lactone-based polyol compound, a polycarbonate-based polyol compound and a polyether-based polyol compound.

21. The method of preparing a porous polyurethane sheet as claimed in claim 15, wherein the isocyanate compound is at least one selected from the group consisting of toluene diisocyanate, diphenylmethane diisocyanate, modified diphenylmethane diisocyanate, naphthalene diisocyanate, phenylene diisocyanate, hexamethylene diisocyanate, lysine isocyanate, cyclohexane diisocyanate, isophorone diisocyanate, xylene diisocyanate, tetramethyl xylene diisocyanate, norbornene diisocyanate, triphenylmethane triisocyanate, polyphenyl polymethylene polyisocyanate, a polyisocyanate compound containing a carbodiimide functional group, a polyisocyanate compound containing an allophanate functional group and a polyisocyanate compound containing an isocyanurate functional group.

22. The method of preparing a porous polyurethane sheet as claimed in claim 15, wherein the isocyanate compound comprises a single molecule typed isocyanate compound containing at least two isocyanate functional groups or an isocyanate prepolymer obtained by an addition reaction of the single molecule typed isocyanate compound and the polyol compound.

23. The method of preparing a porous polyurethane sheet as claimed in claim 22, wherein the isocyanate prepolymer is obtained by the addition reaction carried out at a temperature range of about 20 to about 120° C.

24. The method of preparing a porous polyurethane sheet as claimed in claim 15, wherein the step of mixing and stirring comprises:
a primarily mixing and stirring of the molten urethane polyol prepolymer with the urethane curing catalyst; and
a secondarily mixing and stirring of the thus obtained mixture by the first mixing and stirring with the isocyanate compound containing at least two isocyanate functional groups for reacting with the hydroxyl functional groups.

25. The method of preparing a porous polyurethane sheet as claimed in claim 15, wherein at least one of a foaming stabilizer, an anti-oxidant, an ultraviolet absorbent, a climate-resistance improving agent, a deodorizer, a water permeability improving agent, a conductivity imparting agent, an antistatic agent, a blocking preventing agent, a coupling agent, a water repellent, a hydrolysis preventing agent, a dye, a pigment, a filler, a hollow foaming agent, thermal decomposing-typed foaming agent, a crystal water-containing compound, dioctyl phthalic acid ester, a thermoplastic resin and a thermosetting resin is added during implementing the step of (c).

26. The method of preparing a porous polyurethane sheet as claimed in claim 15, further implementing a step of coating the mechanically foamed material on a sheet shaped body after the step of (d).

27. The method of preparing a porous polyurethane sheet as claimed in claim 26, wherein the sheet shaped body is one of a non-woven fabric, a fiber textile, a plastic sheet and a knitted work.
